(19) United States
(12) Patent Application Publication
(10) Pub. No.: US 2008/0184625 A1
(43) Pub. Date: Aug. 7, 2008

(54) Insulated Animal Door

(75) Inventors: Thomas P. Bjorholm, Knoxville, TN (US); Robert T. Haas, Friendsville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/971,587

(22) Filed: Jan. 9, 2008

Related U.S. Application Data
(60) Provisional application No. 60/888,521, filed on Feb. 6, 2007.

(51) Int. Cl. E06B 3/38; A01K 1/00

(52) U.S. Cl. 49/371; 119/416

(57) ABSTRACT

Described is an animal door for providing an animal a passageway through a structure and for reducing thermal transfer through the passageway. The animal door defines the passageway, which is sufficiently large for the animal to pass through, and is adapted to be secured to the structure such that the animal can pass through the structure by passing through the passageway. The animal door includes at least three flaps disposed at the passageway. The flaps are constructed and configured to reduce thermal transfer through the passageway by reducing both thermal convection and thermal conductivity at the passageway.

### CROSS-REFERENCE TO RELATED APPLICATIONS

This application claims the benefit of U.S. Provisional Application No. 60/888,521, filed Feb. 6, 2007.

### STATEMENT REGARDING FEDERALLY SPONSORED RESEARCH OR DEVELOPMENT

Not Applicable

### BACKGROUND OF THE INVENTION

1. Field of the Invention

This invention pertains to an animal door for providing an animal access through a structure. More particularly, this invention pertains to an animal door for reducing thermal transfer through the door.

2. Description of the Related Art

Conventional pet doors typically include a frame disposed at an opening defined by a structure such that the frame further defines the opening. Additionally, conventional pet doors typically include a single flap attached to the frame such that the flap pivots or flexes freely at the frame and within the opening to the extent that the flap is capable of closed position and an open position. When at the closed position, the flap is designed to obstruct the opening and reduce thermal transfer through the opening. However, the flap of a conventional pet door is typically constructed of a material that is not thermally insulative. Additionally, because the flap of a conventional pet door is designed to pivot freely within the opening, when the flap is at the closed position, there are structural gaps between the flap and the frame. Consequently, the above-discussed conventional pet doors do very little to reduce thermal transfer through the opening. This limitation can increase energy costs for buildings having conventional pets doors and can even lower the comfort level within the building.

Other conventional pet doors have addressed the above-discussed limitation by including flexible seals disposed about particular edges of the flap such that the seals cooperate with the frame to reduce the structural gaps between the closed flap and the frame. Additionally, even other conventional pet doors include a flap that is constructed of a thermally insulative material. Although these conventional pet doors reduce the circulation of air through the opening and the thermal transfer through the flap, the insulated flap is limited in its insulating properties because the size and weight of the flap is limited to that movable by the pet using the pet door.

Yet even other conventional pet doors have addressed the above-discussed limitation by including two flaps, namely a flap disposed at each end of the opening. The two flaps define an enclosure within the pet door. This enclosure is designed to provide an insulative pocket of dead air at the opening. However, these conventional pet doors are limited in that the dimensions of the enclosure are such that the physical phenomena of natural convection occurs, promoting the transfer of heat through the pet door. Stated differently, the distance between the two flaps is too large. Consequently, a pet door that reduces thermal transfer through the pet door by reducing both thermal conductivity and thermal convection is desired.

### BRIEF SUMMARY OF THE INVENTION

In accordance with the various features of the present invention there is provided an animal door for providing an animal a passageway through a structure and for reducing thermal transfer through the passageway. The animal door includes a frame, a first outer flap, a second outer flap, and an inner flap. The frame defines the passageway, which is sufficiently large to the extent that the animal is able to pass through the passageway. The first outer flap and the second outer flap are secured to the frame at the passageway such that the first outer flap and the second outer flap are capable of a closed position and an open position. The inner flap is secured to the frame at the passageway and between the first outer flap and the second outer flap such that the inner flap is capable of the closed position and the open position. When at the closed position, a flap of the present invention substantially obstructs the passageway and cooperates with the frame to generate a substantially airtight seal at the passageway. When at the open position, a flap of the present invention does not obstruct the passageway to the extent that the animal is able to pass through the passageway. When the first outer flap and the inner flap are at the closed position, the first outer flap, the inner flap, and the frame define a first cavity within the passageway. The dimensions of the first cavity are such that the size and geometry of the first cavity discourage thermal convection within the first cavity. Consequently, the first cavity provides a first thermally insulative pocket of dead air within the passageway. Similarly, when the second outer flap and the inner flap are at the closed position, the second outer flap, the inner flap, and the frame define a second cavity within the passageway. The dimensions of the second cavity are such that the size and geometry of the second cavity discourage thermal convection with the second cavity. Consequently, the second cavity provides a second thermally insulative pocket of dead air within the passageway. Additionally, the inner flap is constructed a thermally insulative material, which reduces thermal conductivity within the passageway. Consequently, the animal door reduces thermal transfer through the passageway by reducing thermal convection and thermal conductivity within the passageway.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates one embodiment of the animal door in accordance with the various features of the present invention;

FIG. 2 illustrates an exploded view of the animal door of FIG. 1;

FIG. 3 illustrates the animal door of FIG. 1 secured to a structure;

FIG. 4 illustrates a cross-sectional view of the animal door of FIG. 1; and

FIG. 5 illustrates an alternate embodiment of the animal door of FIG. 1.

### DETAILED DESCRIPTION OF THE INVENTION

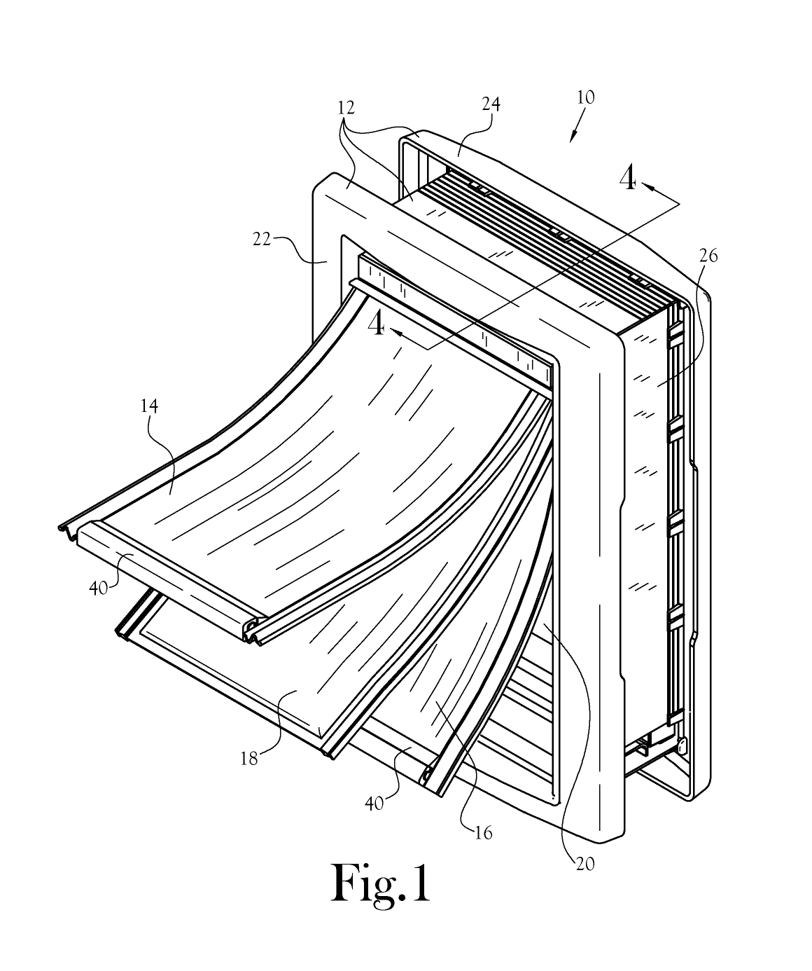

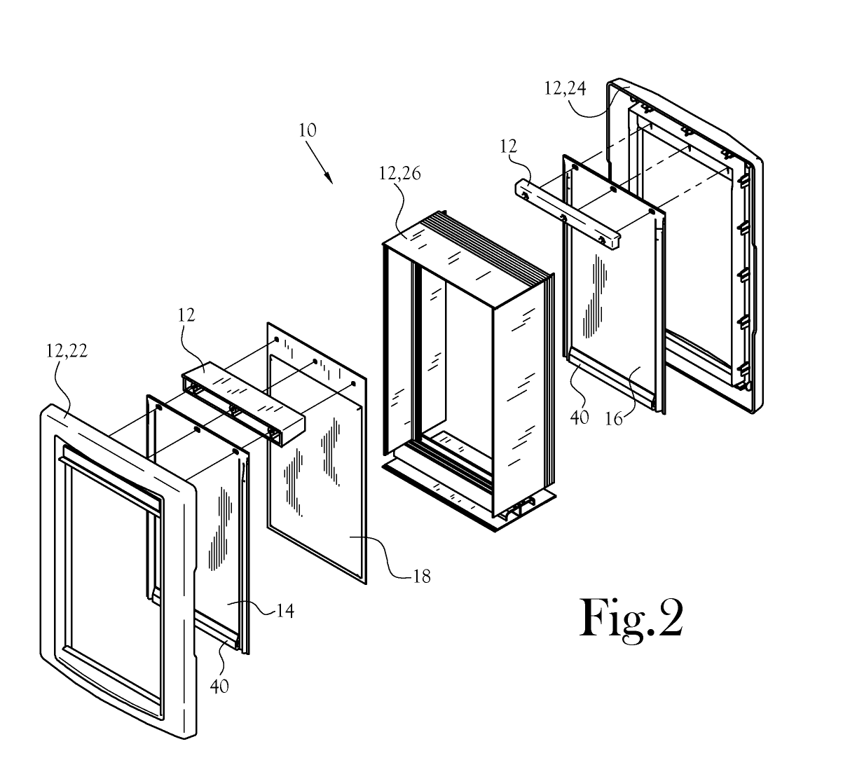

The present invention provides an animal door for providing an animal a passageway through a structure and for reducing thermal transfer through the passageway. The animal door defines the passageway, which is sufficiently large for the animal to pass through, and is adapted to be secured to the structure such that the animal can pass through the structure by passing through the passageway. The animal door includes at least three flaps disposed at the passageway. The flaps are constructed and configured to reduce thermal transfer through the passageway by reducing both thermal convection and thermal conductivity at the passageway. One embodiment of the animal door constructed in accordance with the various features of the present invention is illustrated generally at 10 in FIG. 1 and FIG. 2, FIG. 2 being an exploded view of the animal door 10 of FIG. 1.

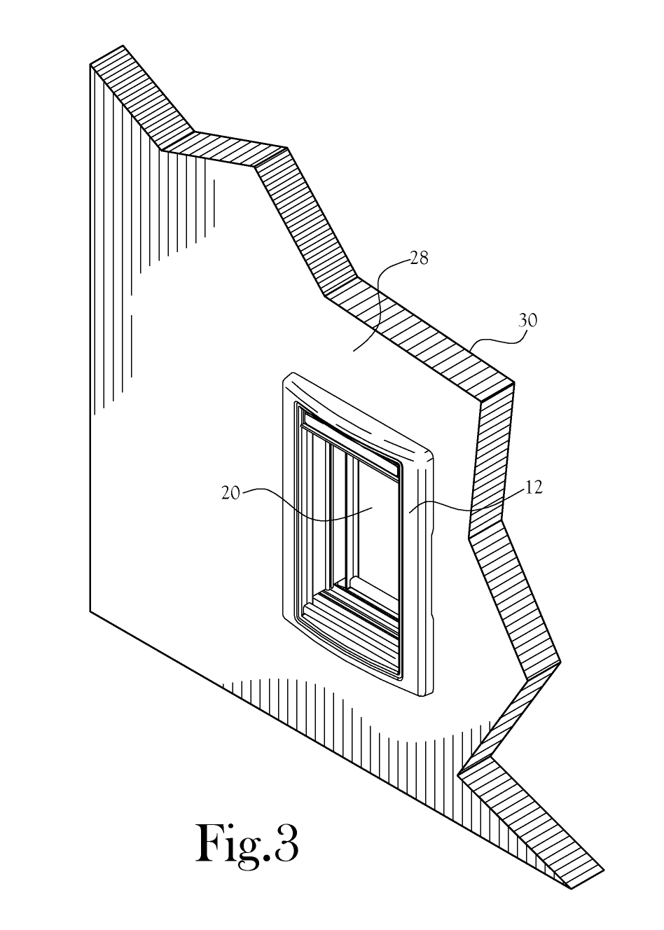

The animal door 10 of FIG. 1 and FIG. 2 includes a frame 12, a first outer flap 14, a second outer flap 16, and an inner flap 18. The frame 12 defines a passageway 20, which is sufficiently large to the extent that an animal can pass through the passageway 20. The frame 12 is adapted to be secured to a structure, such as a door or a wall, which defines an opening. More specifically, the frame 12 is adapted to be secured to the structure such that the passageway 20 is positioned at the opening. Stated differently, when the frame 12 is secured to the structure, the animal passes through the structure by passing through the passageway 20. FIG. 3 illustrates the frame 12 of the animal door 10 of FIGS. 1 and 2 secured to the structure.

Considering again FIG. 1 and FIG. 2, in the illustrated embodiment, the frame 12 includes a first frame member 22, a second frame member 24, and a third frame member 26. The first frame member 22, the second frame member 24, and the third frame member 26 cooperate such that, when secured to the structure, the first frame member 22 is positioned at a first side of the structure 28, the second frame member 24 is positioned at a second side of the structure 30, and the third frame member 26 is positioned within the opening defined by the structure, as illustrated at FIG. 3. The frame members 22, 24, and 26 also cooperate such that frame 12 is adapted to be secured to structures of various depths. It should be noted that the frame 12 can have frame member combinations other than the first frame member 22, the second frame member 24, and the third frame member 26 without departing from the scope or spirit of the present invention. For example, in one embodiment, the animal door 10 includes just the first frame member 22 and the second frame member 24.

Considering again FIG. 1 and FIG. 2, the first outer flap 14 is secured to the frame 12 such that the first outer flap 14 is positioned at the passageway 20. In the illustrated embodiment, the first outer flap 14 is secured to the first frame member 22 at the passageway 20. The first outer flap 14 is capable of a closed position and an open position. When at the closed position, the first outer flap 14 substantially obstructs the passageway 20 and cooperates with the frame 12 to generate a substantially airtight seal at the passageway 20. A substantially airtight seal can be generated by relaxed physical contact between the first outer flap 14 and the frame 12 at the perimeter of the passageway 20. Alternatively, a substantially airtight seal can be generated by a secured physical contact between the first outer flap 14 and the frame 12 at the perimeter of the passageway 20. For example, in the illustrated embodiment, the first outer flap 14 includes a magnetic strip 40 disposed at the bottom edge of the first outer flap 14. The magnetic strip 40 cooperates with the frame 12 to guide the first outer flap 14 to the closed position within the frame 12, aiding the first outer flap 14 and the frame 12 in generating a substantially airtight seal. It should be noted that the first outer flap 14 and the frame 12 can generate a substantially airtight seal at the passageway 20 without the implementation of the magnetic strip 40 or any other device for guiding the first outer flap 14 to the closed position.

When at the open position, the first outer flap 14 does not obstruct the passageway 20 to the extent that the animal can pass through the passageway 20 as discussed above. In the illustrated embodiment, the first outer flap 14 is constructed of a substantially flexible material such that when the first outer flap 14 is secured to the frame 12, the first outer flap 14 flexes bi-directionally between the open position and the closed position in response to the appropriate forces. For example, when gravity is the only force applied to the first outer flap 14, the first outer flap 14 is forced to the closed position. When the animal passes through the passageway 20 and pushes against the first outer flap 14 accordingly, the first outer flap 14 is forced to the open position. In another embodiment, the first outer flap 14 is constructed of a substantially rigid material and is secured to the frame 12 by way of a hinge member such that the first outer flap 14 pivots bi-directionally at the hinge member between the open position and the closed position in response to the appropriate forces. In one embodiment, the first outer flap 14 is constructed of a weather resistant material such that, when at the closed position, the first outer flap 14 prevents moisture and other environmental elements from entering the passageway 20.

The second outer flap 16 is secured to the frame 12 such that the second outer flap 16 is positioned at the passageway 20. In the illustrated embodiment, the second outer flap 16 is secured to the second frame member 24 at the passageway 20. The second outer flap 16 is capable of the open position and the closed position. When at the closed position, the second outer flap 16 substantially obstructs the passageway 20 and cooperates with the frame 12 to generate a substantially airtight seal at the passageway 20. A substantially airtight seal can be generated by relaxed physical contact between the second outer flap 16 and the frame 12 at the perimeter of the passageway 20. Alternatively, a substantially airtight seal can be generated by a secured physical contact between the second outer flap 16 and the frame 12 at the perimeter of the passageway 20. For example, in the illustrated embodiment, the second outer flap 16 includes a magnetic strip 40 disposed at the bottom edge of the second outer flap 16. The magnetic strip 40 cooperates with the frame 12 to guide the second outer flap 16 to the closed position within the frame 12, aiding the second outer flap 16 and the frame 12 in generating a substantially airtight seal. It should be noted that the second outer flap 16 and the frame 12 can generate a substantially airtight seal at the passageway 20 without the implementation of the magnetic strip 40 or any other device for guiding the second outer flap 16 to the closed position.

When at the open position, the second outer flap 16 does not obstruct the passageway 20 to the extent that the animal can pass through the passageway 20 as discussed above. In the illustrated embodiment, the second outer flap 16 is constructed of a substantially flexible material such that when the second outer flap 16 is secured to the frame 12, the second outer flap 16 flexes bi-directionally between the open position and the closed position in response to the appropriate forces. In another embodiment, the second outer flap 16 is constructed of a substantially rigid material and is secured to the frame 12 by way of a hinge member such that the second outer flap 16 pivots bi-directionally at the hinge member between the open position and the closed position in response to the appropriate forces. In one embodiment, the second outer flap 16 is constructed of a weather resistant material such that, when at the closed position, the second outer flap 16 prevents moisture and other environmental elements from entering the passageway 20.

The inner flap 18 is secured to the frame 12 such that the inner flap 18 is positioned at the passageway 20 and between the first outer flap 14 and second outer flap 16. The inner flap 18 is capable of the open position and the closed position. When at the closed position, the inner flap 18 substantially obstructs the passageway 20 and cooperates with the frame 12 to generate a substantially airtight seal at the passageway 20. A substantially airtight seal can be generated by relaxed physical contact between the inner flap 18 and the frame 12 at the perimeter of the passageway 20. When at the open position, the inner flap 18 does not obstruct the passageway 20 to the extent that the animal can pass through the passageway 20 as discussed above. In the illustrated embodiment, the inner flap 18 is constructed of a substantially flexible material such that when the inner flap 18 is secured to the frame 12, the inner flap 18 flexes bi-directionally between the open position and the closed position in response to the appropriate forces. In another embodiment, the inner flap 18 is constructed of a substantially rigid material and is secured to the frame 12 by way of a hinge member such that the inner flap 18 pivots bi-directionally at the hinge member between the open position and the closed position in response to the appropriate forces.

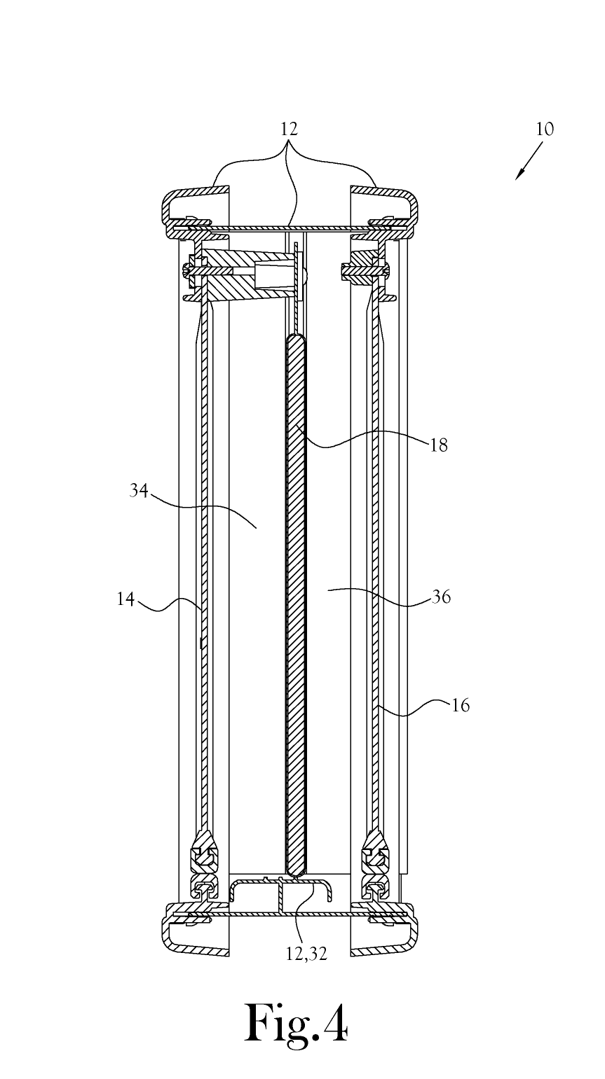

FIG. 4 is a cross-sectional view of the animal door 10 of FIG. 1 taken at lines 4-4. In the illustrated embodiment, the frame 12 defines a raised member 32 that defines a portion of the passageway 20. The raised member 32 is in physical contact with the inner flap 18 when the inner flap 18 is at the closed position to the extent that the inner flap 18 and the frame 12 generate a substantially airtight seal at the passageway 20 in accordance with the above-discussion. When the first outer flap 14 and the inner flap 18 are at the closed position, the first outer flap 14, the inner flap 18, and the frame 12 define a first cavity 34 within the passageway 20. Similarly, when the second outer flap 16 and the inner flap 18 are at the closed position, the second outer flap 16, the inner flap 18, and the frame 12 define a second cavity 36 within the passageway 20. The dimensions of the first cavity 34 are such that the size and geometry of the first cavity 34 discourage thermal convection within the first cavities 34. Similarly, the dimensions of the second cavity 36 are such that the size and geometry of the second cavity 36 discourage thermal convection within the second cavity 36. Stated differently, the distance between the first outer flap 14 and the inner flap 18 and the distance between the second outer flap 16 and the inner flap 18 is sufficiently small to discourage thermal convection. Because thermal convection within the first cavity 34 and the second cavity 36 is discouraged, the first cavity 34 and the second cavity 36 provide respective thermally insulative pockets of dead air at the passageway 20.

In addition to reducing thermal convection within the passageway 20, the pet door 10 reduces thermal conduction through the passageway 20. More specifically, the inner flap 18 is constructed of a substantially thermally insulative material. For example, the inner flap 18 can be constructed of polystyrene (a closed-cell plastic foam), closed-cell polyurethane, open-cell polyurethane, or polyisocyanurate. Alternatively, the inner flap 18 can include a thermally insulative fabric such as Thinsulate® (3M Corporation). It should be noted that the inner flap 18 can be constructed of a thermally insulative material other than the specifically discussed examples above without departing from the scope or spirit of the present invention. Because the inner flap 18 is constructed of thermally insulative material, the inner flap 18 reduces thermal conductivity through the passageway 20. Consequently, because the first cavity 34 and the second cavity 36 discourage thermal convection within the passageway 20 and because the inner flap 18 reduces thermal conductivity through the passageway 20, the animal door 10 reduces the thermal transfer through the passageway 20.

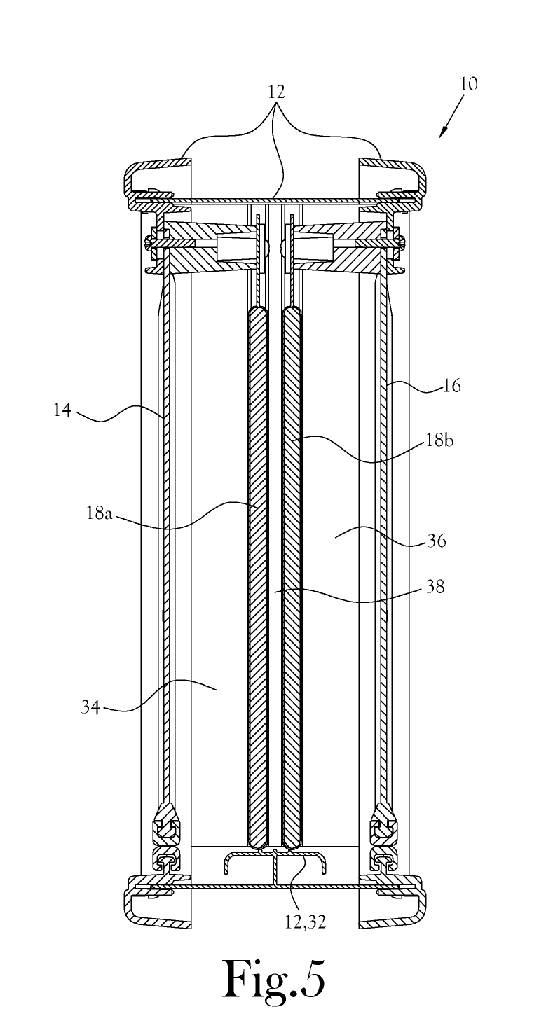

FIG. 5 illustrates an alternate embodiment of the animal door 10 in accordance with the various features of the present invention. In the alternate embodiment, the inner flap 18 includes a first inner flap 18a and a second inner flap 18b. In the illustrated embodiment, when the first outer flap 14 and the first inner flap 18a are at the closed position, the first outer flap 14, the first inner flap 18a, and the frame 12 define the first cavity 34. Similarly, when the second outer flap 16 and the second inner flap 18b are at the closed position, the second outer flap 16, the second inner flap 18b, and the frame 12 define the second cavity 36. And when the first inner flap 18a and the second inner flap 18b are at the closed position, the first inner flap 18a, the second inner flap 18b, and the frame 12 define a third cavity 38. Similar to the respective dimensions of the first cavity 34 and the second cavity 36, the dimensions of the third cavity 38 are such that the size and geometry of the third cavity 38 discourage thermal convection within the third cavity 38. Consequently, the first cavity 34, the second cavity 36, and the third cavity 38 provide respective thermally insulative pockets of dead at the passageway 20. Additionally, similar to the inner flap 18, the first inner flap 18a and the second inner flap 18b are constructed of a substantially thermally insulative material. Consequently, the first inner flap 18a and the second inner flap 18b further reduce thermal conductivity through the passageway 20. Because the first cavity 34, the second cavity 36, and the third cavity 38 discourage thermal convection within the passageway 20 and because the first inner flap 18a and the second inner flap 18b reduce thermal conductivity through the passageway 20, the animal door 10 reduces the thermal transfer through the passageway 20. It should be noted that the number of inner flaps 18 included by the animal door 10 can vary without departing from the scope or spirit of the present invention.

From the foregoing description, those skilled in the art will recognize that an animal door for providing an animal a passageway through a structure offering advantages over the prior art has been provided. More specifically, the animal door defines the passageway, which is sufficiently large for the animal to pass through, and is adapted to be secured to the structure such that the animal can pass through the structure by passing through the passageway. The animal door includes at least three flaps disposed at the passageway. The flaps are constructed and configured to reduce thermal transfer through the passageway by reducing both thermal convection and thermal conductivity at the passageway.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An animal door for reducing thermal transfer through said animal door, said animal door comprising:
a frame having a first frame member and a second frame member, said frame defining a passageway, the passageway being sufficiently large to the extent that an animal is able to pass through the passageway, said frame adapted to be secured to a structure having an opening;
a first outer flap secured to said frame at the passageway and at the first frame member, said first outer flap being secured to said frame such that said first outer flap is moveable between a closed position and an open position, said first outer flap substantially obstructing the passageway and cooperating with said frame to generate a substantially airtight seal at the passageway when said first outer flap is at the closed position, said first outer flap not obstructing the passageway to the extent that the animal is able to pass through the passageway when said first outer flap is at the open position;
a second outer flap secured to said frame at the passageway and at the second frame member, said second outer flap being secured to said frame such that said second outer flap is moveable between the closed position and the open position, said second outer flap substantially obstructing the passageway and cooperating with said frame to generate a substantially airtight seal at the passageway when said second outer flap is at the closed position, said second outer flap not obstructing the passageway to the extent that the animal is able to pass through the passageway when said second outer flap is at the open position; and
an inner flap secured to said frame at the passageway and between said first outer flap and said second outer flap, said inner flap being secured to said frame such that said inner flap is moveable between the closed position and the open position, said inner flap substantially obstructing the passageway and cooperating with said frame to generate a substantially airtight seal at the passageway when said inner flap is at the closed position, said inner flap not obstructing the passageway to the extent that the animal is able to pass through the passageway when said inner flap is at the open position, said inner flap being constructed of a substantially thermally insulative material, said first outer flap, said inner flap, and said frame defining a first cavity within the passageway when said first outer flap and said inner flap are at the closed position, the first cavity being substantially airtight and having dimensions that discourage thermal convection within the first cavity, said second outer flap, said inner flap, and said frame defining a second cavity within the passageway when said second outer flap and said inner flap are at the closed position, the second cavity being substantially airtight and having dimensions that discourage thermal convection within the second cavity.

2. The animal door of claim 1 wherein said first outer flap and said second outer flap are constructed of a substantially flexible material such that said first outer flap and said second outer flap flex between the open position and the closed position.

3. The animal door of claim 1 wherein said first outer flap and said second outer flap pivot at said frame between the open position and the closed position.

4. The animal door of claim 1 wherein said first outer flap and said second outer flap are constructed of a substantially thermally insulative material.

5. The animal door of claim 1 wherein said first outer flap and said second outer flap are constructed of a weather resistant material.

6. The animal door of claim 1 wherein said inner flap is constructed of a substantially flexible material such that said inner flap flexes between the open position and the closed position.

7. The animal door of claim 1 wherein said inner flap pivots at said frame between the open position and the closed position.

8. The animal door of claim 1 wherein said inner flap includes a first inner flap and a second inner flap, said first inner flap, said second inner flap, and said frame defining a third cavity within the passageway when said first inner flap and said second inner flap are at the closed position, the third cavity being substantially airtight and having dimensions that discourage thermal convection within the third cavity.

9. An animal door for reducing thermal transfer through said animal door, said animal door comprising:
a frame defining a passageway;
a first outer flap secured to said frame at the passageway, said first outer flap being moveable between a closed position and an open position;
a second outer flap secured to said frame at the passageway, said second outer flap being moveable between the closed position and the open position; and
an inner flap secured to said frame at the passageway and between said first outer flap and said second outer flap, said inner flap being moveable between the closed position and the open position, said first outer flap, said inner flap, and said frame defining a first cavity within the passageway when said first outer flap and said inner flap are at the closed position, the dimensions of the first cavity being such that thermal convection within the first cavity is discouraged, said second outer flap, said inner flap, and said frame defining a second cavity within the passageway when said second outer flap and said inner flap are at the closed position, the dimensions of the second cavity being such that thermal convection within the second cavity is discouraged.

10. The animal door of claim 9 wherein said inner flap is constructed of a substantially thermally insulative material.

11. The animal door of claim 9 wherein said inner flap includes a plurality of inner flaps, said plurality of inner flaps and said frame defining at least a third cavity within the passageway when each of said plurality of inner flaps is at the closed position, the dimensions of the at least third cavity being such that thermal convection within the at least third cavity is discouraged.

12. The animal door of claim 9 wherein said inner flap substantially obstructs the passageway and cooperates with said frame to generate a substantially airtight seal at the passageway when said inner flap is at the closed position.

13. The animal door of claim 9 wherein said first outer flap substantially obstructs the passageway and cooperates with said frame to generate a substantially airtight seal at the passageway when said first outer flap is at the closed position.

14. The animal door of claim 9 wherein said second outer flap substantially obstructs the passageway and cooperates with said frame to generate a substantially airtight seal at the passageway when said second outer flap is at the closed position.

15. An animal door for reducing thermal transfer through said animal door, said animal door comprising:
a frame defining a passageway, the passageway being sufficiently large to the extent that an animal is able to pass through the passageway, said frame adapted to be secured to a structure having an opening;
a first outer flap secured to said frame at the passageway, said first outer flap being moveable between a closed position and an open position, said first outer flap substantially obstructing the passageway and cooperating with said frame to generate a substantially airtight seal at the passageway when said first outer flap is at the closed position, said first outer flap not obstructing the passageway to the extent that the animal is able to pass through the passageway when said first outer flap is at the open position;
a second outer flap secured to said frame at the passageway, said second outer flap being moveable between the closed position and the open position, said second outer flap substantially obstructing the passageway and cooperating with said frame to generate a substantially airtight seal at the passageway when said second outer flap is at the closed position, said second outer flap not obstructing the passageway to the extent that the animal is able to pass through the passageway when said second outer flap is at the open position;
a first inner flap secured to said frame at the passageway, said first inner flap being moveable between the closed position and the open position, said first inner flap substantially obstructing the passageway and cooperating with said frame to generate a substantially airtight seal at the passageway when said first inner flap is at the closed position, said first inner flap not obstructing the passageway to the extent that the animal is able to pass through the passageway when said first inner flap is at the open position, said first inner flap being constructed of substantially thermally insulative material; and
a second inner flap secured to said frame at the passageway, said second inner flap being moveable between the closed position and the open position, said second inner flap substantially obstructing the passageway and cooperating with said frame to generate a substantially airtight seal at the passageway when said second inner flap is at the closed position, said second inner flap not obstructing the passageway to the extent that the animal is able to pass through the passageway when said second inner flap is at the open position, said second inner flap being constructed of substantially thermally insulative material, said first inner flap being positioned between said first outer flap and said second inner flap, said second inner flap being positioned between said second outer flap and said first inner flap, said first outer flap, said first inner flap, and said frame defining a first cavity within the passageway when said first outer flap and said first inner flap are at the closed position, the first cavity being substantially airtight and having dimensions that discourage thermal convection within the first cavity, said first inner flap, said second inner flap, and said frame defining a second cavity within the passageway when said first inner flap and said second inner flap are at the closed position, the second cavity being substantially airtight and having dimensions that discourage thermal convection within the second cavity, said second inner flap, said second outer flap, and said frame defining a third cavity within the passageway when said second inner flap and said second outer flap are at the closed position, the third cavity being substantially airtight and having dimensions that discourage thermal convection within the third cavity.
